(19) United States
(12) Patent Application Publication
(10) Pub. No.: US 2018/0218204 A1
(43) Pub. Date: Aug. 2, 2018

(54) SYSTEMS AND METHODS FOR SYNCHRONIZING TIMING BETWEEN AN INDIVIDUAL LEADER AND ONE OR MORE PEOPLE

(71) Applicants: Stephen Phillip Kasmir, San Diego, CA (US); Seton Paul Kasmir, San Diego, CA (US)

(72) Inventors: Stephen Phillip Kasmir, San Diego, CA (US); Seton Paul Kasmir, San Diego, CA (US)

(21) Appl. No.: 15/885,199

(22) Filed: Jan. 31, 2018

Related U.S. Application Data
(60) Provisional application No. 62/452,942, filed on Jan. 31, 2017.
(60) Provisional application No. 62/455,811, filed on Feb. 7, 2017.

(51) Int. Cl. G06K 9/00; G06F 1/16; G10G 7/00

(52) U.S. Cl. CPC G06K 9/00355; G06F 1/163; G10H 2240/211; G10H 2220/206; G10H 2220/395; G10G 7/00

(57) ABSTRACT

The disclosure includes a musical timing system that comprises a band leader body worn device. The band leader body worn device may include an accelerometer arranged and configured to track a motion and determine at least one of a rhythm and beat from a pattern. The band leader body worn device may also include a processor communicatively coupled to the accelerometer. The processor may be arranged and configured to determine timing information from the at least one of the rhythm and beat from the pattern. The band leader body worn device may also include a radio communicatively coupled to the processor. The radio may be arranged and configured to transmit the timing information to a group device.

### CROSS-REFERENCE TO RELATED APPLICATIONS

The entire contents of the following application are incorporated by reference herein: U.S. Provisional Patent Application No. 62/452,942; filed Jan. 31, 2017; and entitled METHODS OF SYNCHRONIZING TIMING BETWEEN AN INDIVIDUAL LEADER AND A GROUP OF ONE OR MORE PEOPLE.

The entire contents of the following application are incorporated by reference herein: U.S. Provisional Patent Application No. 62/455,811; filed Feb. 7, 2017; and entitled METHODS OF SYNCHRONIZING TIMING BETWEEN AN INDIVIDUAL LEADER AND A GROUP OF ONE OR MORE PEOPLE.

### BACKGROUND

### Field

Various embodiments disclosed herein relate to synchronization devices. Certain embodiments relate to synchronization devices that synchronize a band member with a band leader.

### Description of Related Art

A band leader, conductor or drum major uses a baton and hand-arm movements to visually synchronize the musical timing or tempo with a group of members playing in a marching band. If a member cannot see the band leader because of an obstruction, the band member can lose the synchronization of their playing with the music tempo presented by the band leader. If a member of the band cannot see but can hear the band, the slow propagation of sound can further throw off their synchronization. An individual substituting the sound from the band will receive tempo timing that is quite delayed relative to the visual cues of the hand and baton motion by the band leader. Thus, there exists a need for a system that synchronizes a band member with a band leader that overcomes the challenges described above.

### SUMMARY

The disclosure includes a musical timing system, comprising a band leader body worn device. The band leader body worn device may include an accelerometer arranged and configured to track a motion and determine at least one of a rhythm and beat from a pattern; a processor communicatively coupled to the accelerometer, wherein the processor is arranged and configured to determine timing information from the at least one of the rhythm and beat from the pattern; and a radio communicatively coupled to the processor, wherein the radio is arranged and configured to transmit the timing information to a group device.

The system may include a power source electrically coupled to the radio. The power source may comprise a battery. The power source may comprise an energy harvesting device arranged and configured to use kinetic energy of a movement associated with the motion.

In some embodiments, the system includes an antenna communicatively coupled to the radio. The antenna may be arranged and configured to transmit the timing information.

The system may further include a group device communicatively coupled to the band leader body worn device. The group device may include a second processor arranged and configured to determine the timing information; and a second radio communicatively coupled to the second processor, wherein the second radio is arranged and configured to receive the timing information. The group device may be remotely located with respect to the band leader body worn device. The group device may further include a second battery electrically coupled to the second radio; a second antenna communicatively coupled to the second radio, wherein the second antenna is arranged and configured to receive the timing information; a speaker communicatively coupled to the second radio, the speaker arranged and configured to audibly transmit the timing information; and a vibrating device communicatively coupled to the second radio, the vibrating device arranged and configured to vibrate in accordance with the timing information.

In some embodiments, the system includes a repeater communicatively coupled to the band leader body worn device and the group device. The repeater may be arranged and configured to receive timing information from the band leader body worn device and transmit information related to the timing information to the group device. The information may the timing information.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIGS. 1, 2, 3, 4, 5, 6, 7, 8, and 9 illustrate diagrammatic views of devices, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Problem

This invention synchronizes the timing between an individual or central timing device and a group whether or not persons in the group can see the leader. A band leader, conductor or drum major uses a baton and hand-arm movements to visually synchronize the musical timing or tempo with a group of members playing in a marching band. If a member cannot see the band leader because of an obstruction or when not facing the band leader during a concert, marching band performance or drumline where a member isn't allowed to look directly at the conductor, the band members can lose the synchronization of their playing with the music tempo presented by the band leader. If a member of the band cannot see but can hear the band, the slow propagation of sound can further throw off their synchronization. An individual substituting the sound from the band will receive tempo timing that is quite delayed relative to the visual cues of the hand and baton motion by the band leader.

Oftentimes a group of individuals requiring group members synchronized to a musical tempo may not have a person available or want an individual to perform the visual synchronization functions of a band conductor. In this case a central synchronizing device substitutes for the band conductor.

In a musical stage production, the conductor of the band may be required to have members on stage or on set synchronized with the band leader.

For recording studios for singing or lip synching to a song or animated feature a person can synchronize their voice for a recording without hearing or seeing the recording or cartoon.

### Solution

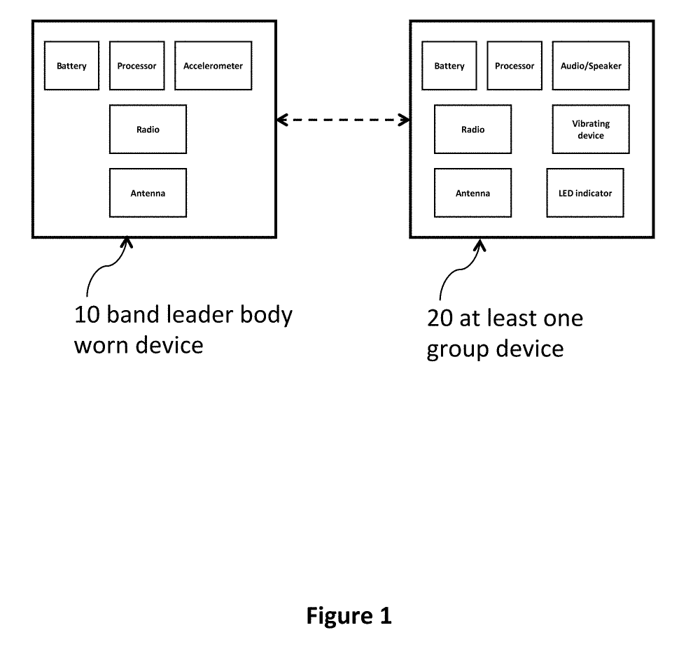

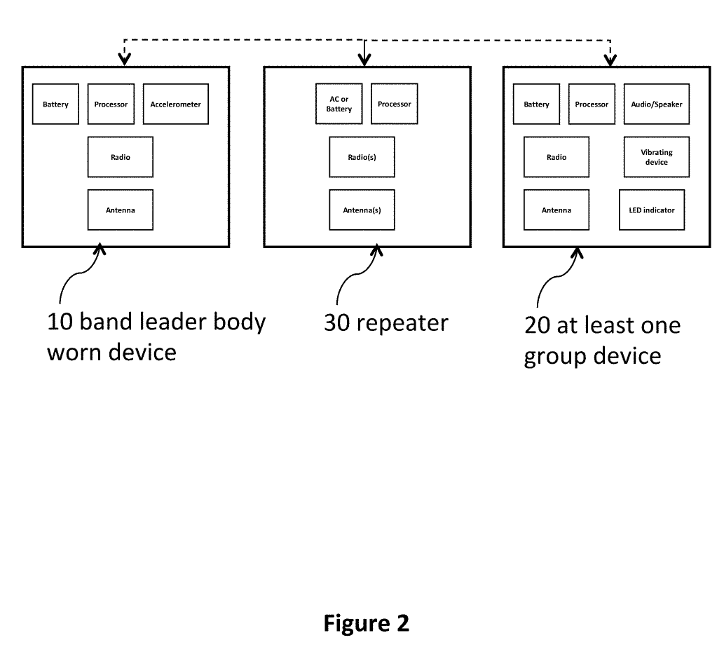

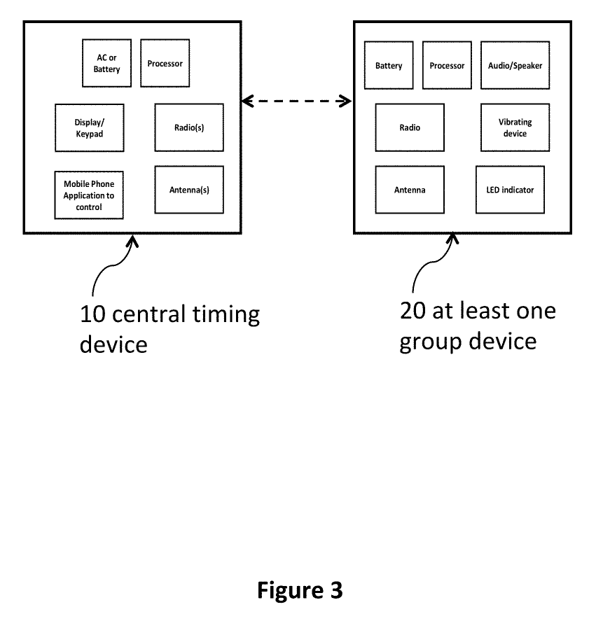

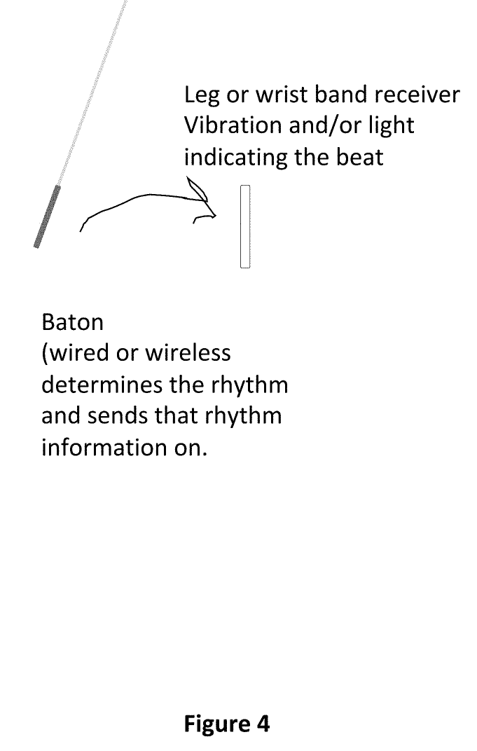

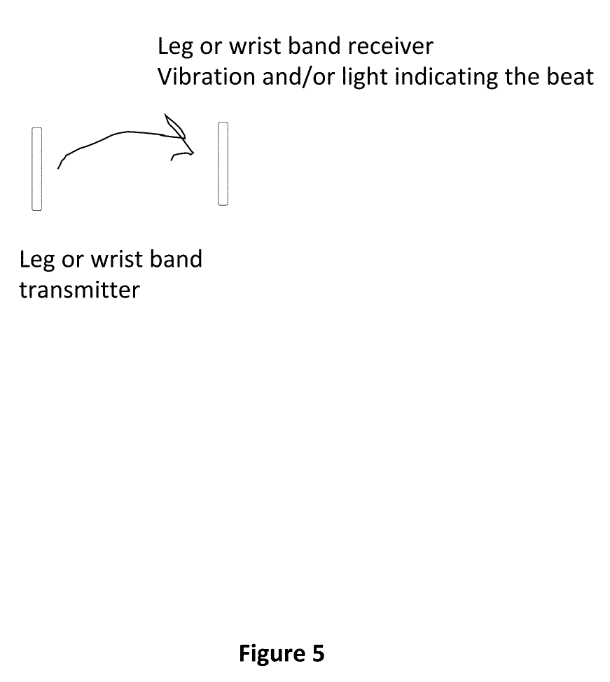

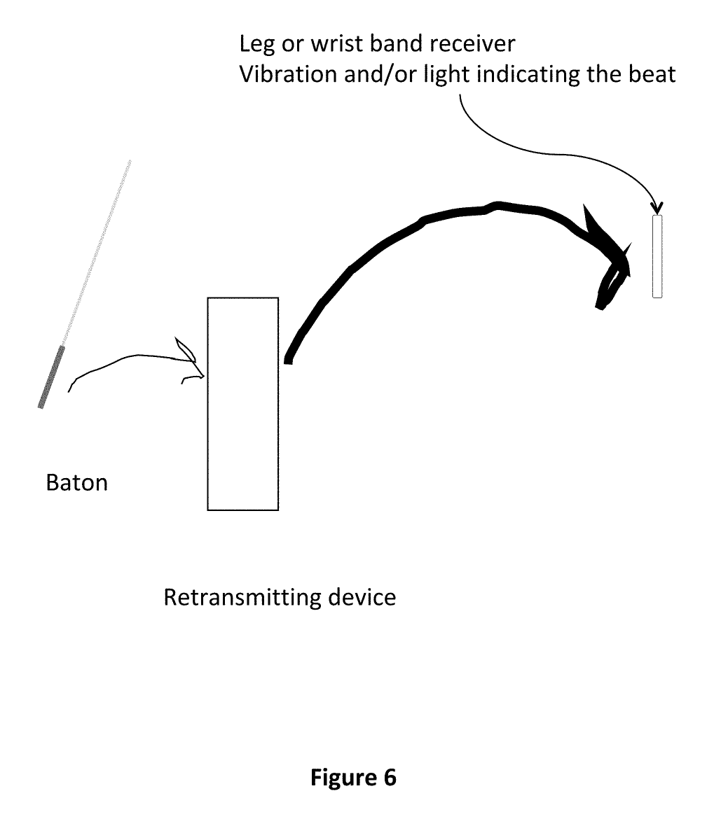

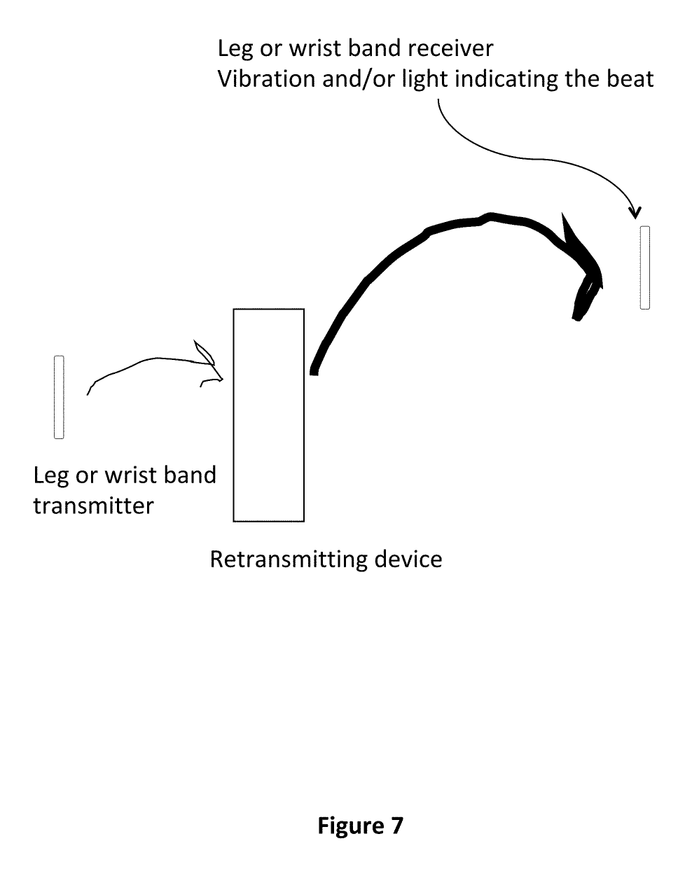

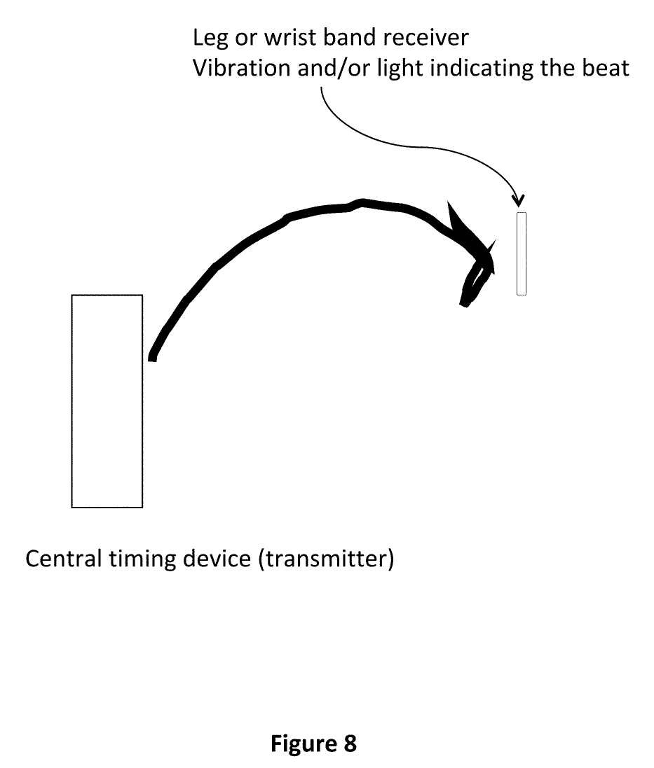

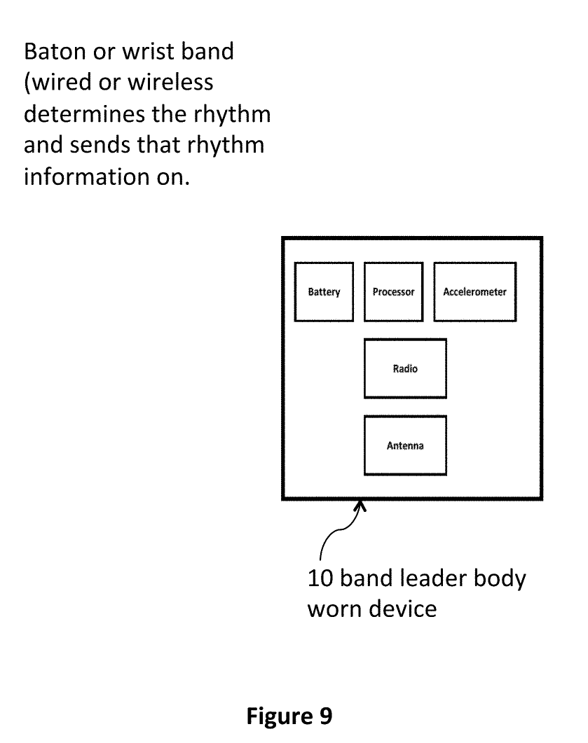

As illustrated in FIGS. 1-9, a band leader body worn device 10 powered by a battery is worn by the band leader, band conductor or drum major. As the name implies, the band leader body worn device 10 may be worn on the body of the band leader, band conductor, and/or drum major. The band leader body worn device 10 may thereby monitor body movements to extract or determine the musical tempo, timing or beat.

The band leader body worn device 10 may provide musical tempo to synchronize the members in the band. The band leader body worn device 10 may use a low power wireless radio to send a signal containing timing synchronization information directly or through a wireless repeater 30 to a group device 20 worn on the body or instrument of group members that indicates to the member the musical tempo, timing or beat.

For instances when individuals in a group may not have a person available or want an individual to perform visual synchronization of the band conductor, the band leader body worn device 10 may be a central master musical timing device 10a broadcasts the musical timing or beat to the individuals wearing a group device 20 or to a device they can watch with a visual indication of the musical timing. The central master musical timing device 10a may be coupled to a person, such as the band conductor or even a band member, or it may be standalone device, not attached to any person. The central master musical timing device 10a may be coupled to a musical instrument. In some embodiments, the central master musical timing device 10a is fixed in place with respect to the band.

### More Details of the Solution

The timing source may be either a person, such as a conductor (his arm and baton displaying the beat) or member of a group (their leg marking the beat), or an electronic timing device that requires this central timing information to be sent to one or more members (a group, band etc.). In embodiments where a person is the central timing source, the device may be referred to as a band leader body worn device 10 that is arranged and configured to determine musical timing (beat) from physical motion, such as motion from an object (e.g. a baton) or a human body part (e.g. a leg, arm, hand, wrist band and the like). The band leader body worn device 10 may include an accelerometer for tracking the motion and determining the rhythm or beat from a pattern that either it detects or knows from preset patterns. Accordingly, he band leader body worn device 10 may be worn on the body to track body motion that represents musical timing or beat, such as by tracking a wristband, a leg band, and/or a belt. The band leader body worn device 10 may include several components.

In some embodiments, the device 10, which may include the band leader body worn device 10 and/or the central master musical timing device 10a, includes a battery and or an energy harvesting device using the kinetic energy of the movement for power. The device 10 may include an accelerometer that tracks the pertinent body motion in x, y and/or z dimensions. The device 10 may also include a processor for interfacing to the accelerometer and a low power radio, such as but not limited to an ISM, Wi-Fi or BLE radio.

The individual may set the timing through a movement of a body part, such as a wristband to track arm and hand motion. The processor may thereby determine the synchronization timing information that represents the music tempo or beat timing from the motion of the wrist band using the accelerometer. The processor may thereby send the synchronization timing information using a radio directly to the group or through a repeater 30 to at least one group device 20. In embodiments where the device 10 transmits the timing information to through a repeater 30 through to the at least one group device 20, the repeater 30 may retransmit the signal from the individual or group or it can use timing information sent over the radio from the individual and determine when to send out the timing information to the group.

Individuals in the group may carry a device, such as a group device 20, that can be attached to the body of the band member. The group device 20 may include a low power radio, which is not limited to BLE, or ISM or Wi-Fi. The group device 20 may be attached to something the individual is carrying or wearing such as the musical instrument. The group device 20 may include a battery and/or an energy harvesting device that uses kinetic energy to supply power. The group device 20 may use the received radio signal containing or representing the synchronization timing information to indicate the band leader's musical tempo, or beat to individuals in the group wearing the body device either by vibration, light and/or by emitting a tone.

When no person can provide visual conducting, a central device 10a can also disseminate musical tempo, beat or timing that is contained in synchronization information transmitted to individuals in a group. The musical beat or timing can be preset or controlled by a person or persons. Individuals in the group can either mount the receiving device (e.g. group device 20) that indicates the central musical timing to be seen or sensed through sound or vibration.

In some embodiments, the device 10 and/or the group device 20 may be directly or indirectly communicatively coupled with a camera that observes the object or human body part in motion. The camera may then determine the rhythm or beat through processing the visual motion.

Once the device 10 has determined the beat, the device 10 may convey this timing wirelessly or through wires directly to at least one group device 20 so the other members can receive the timing. It should be appreciated that the device 10 may convey (e.g. transmit) the timing through a secondary device (e.g. a repeater 30, server, smart phone, tablet, and the like) that relays the rhythm or beat to the group device 20 associated with other members of a group or band. The device 10 may convey the timing directly to at least one group device 20. The device worn or that can display the timing may receive the rhythm information directly from the conductor or a central timing device. The rhythm timing may be relayed to the use by vibration, sound or light. In this regard, the central timing device, instead of a person, will either locally or through a relaying device send the information to the group or band.

In some embodiments, the device 10, including the conductor baton or wrist device requiring no external power, includes a processing element (computer), an accelerometer, radio, antenna and/or battery. The accelerometer may track the motion and send the tracking information to a processing element that can determine from the tracking information the rhythm or beat. The rhythm information may be in the form of a data packet, whereby the information may be sent to the radio transceiver (transmitter and receiver). The radio and antenna may thereby rebroadcast the rhythm information (e.g. to a group device 20) so that a receiver can determine the information.

The group device 20 may include an antenna and radio transceiver for receiving the data containing the rhythm information and a processor that interprets the rhythm information. The processor may make the information available to the receiver using an audio driver, a speaker, a vibrating device, an LED indicator, and/or a battery or power source.

Furthermore, the repeater 30 device may use an antenna and/or radio to receive the rhythm information data, a processor that receives the rhythm information from the radio and sends the information to the same or an additional radio and antenna so it can be received by the user (member of the group or band).

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A musical timing system, comprising:
a band leader body worn device including:
an accelerometer arranged and configured to track a motion and determine at least one of a rhythm and beat from a pattern;
a processor communicatively coupled to the accelerometer, wherein the processor is arranged and configured to determine timing information from the at least one of the rhythm and beat from the pattern; and
a radio communicatively coupled to the processor, wherein the radio is arranged and configured to transmit the timing information to a group device.

2. The system of claim 1, further comprising a power source electrically coupled to the radio.

3. The system of claim 2, wherein the power source comprises a battery.

4. The system of claim 2, wherein the power source comprises an energy harvesting device arranged and configured to use kinetic energy of a movement associated with the motion.

5. The system of claim 1, further comprising an antenna communicatively coupled to the radio, wherein the antenna is arranged and configured to transmit the timing information.

6. The system of claim 1, further comprising a group device communicatively coupled to the band leader body worn device, the group device including:
a second processor arranged and configured to determine the timing information; and
a second radio communicatively coupled to the second processor, wherein the second radio is arranged and configured to receive the timing information.

7. The system of claim 6, wherein the group device is remotely located with respect to the band leader body worn device.

8. The system of claim 7, wherein the group device further includes:
a second battery electrically coupled to the second radio;
a second antenna communicatively coupled to the second radio, wherein the second antenna is arranged and configured to receive the timing information;
a speaker communicatively coupled to the second radio, the speaker arranged and configured to audibly transmit the timing information; and
a vibrating device communicatively coupled to the second radio, the vibrating device arranged and configured to vibrate in accordance with the timing information.

9. The system of claim 6, further comprising a repeater communicatively coupled to the band leader body worn device and the group device, wherein the repeater is arranged and configured to receive timing information from the band leader body worn device and transmit information related to the timing information to the group device.

10. The system of claim 9, wherein the information comprises the timing information.
